(19) United States
(12) Patent Application Publication
(10) Pub. No.: US 2007/0270260 A1
(43) Pub. Date: Nov. 22, 2007

(54) Hub carrier with interchangeable sprockets having different teeth configurations

(76) Inventor: Andrew V. Latham, Ridgefield, NJ (US)

Correspondence Address: ABELMAN, FRAYNE & SCHWAB, 666 THIRD AVENUE, 10TH FLOOR, NEW YORK, NY, 10017, US

(21) Appl. No.: 11/436,793

(22) Filed: May 17, 2006

(51) Int. Cl. F16H 55/30

(52) U.S. Cl. 474/152

(57) ABSTRACT

A sprocket assembly for a vehicle includes a sprocket hub with an interchangeable sprocket ring. The sprocket hub includes a plurality of outwardly extending flanges and means for mounting the sprocket hub to the vehicle. The sprocket ring includes a plurality of outer spaced teeth extending outwardly from the sprocket ring for engaging a drive loop of the vehicle. The sprocket ring further includes a plurality of inwardly extending flanges, each inwardly extending flange is configured to interface with a corresponding outwardly extending flange of the sprocket hub. The sprocket ring is aligned and laterally secured to the sprocket hub by a plurality of removable fasteners. The sprocket ring is one of a plurality of interchangeable sprocket rings that can be mounted on the hub. Each sprocket ring can be configured differently to provide different levels of power transfer suitable for different track conditions.

### FIELD OF INVENTION

The present invention relates to sprockets for motorized vehicles, and more specifically, to a sprocket with an interchangeable sprocket ring.

### BACKGROUND OF THE INVENTION

All terrain motorized vehicles (ATVs), and especially motorcycles used in dirt bike racing, require as much controllable rear wheel traction as possible. During racing conditions where, for example, when the motorcycle racer is trying to achieve maximum acceleration in a straight line or when he leans into a turn, engine power pulses force the rear tire to rotate through the transmission gears (multiple ratios) and the drive line sprockets. The drive sprocket is positioned on the countershaft or gearbox shaft, while a second sprocket located on the rear wheel is driven by a chain that is looped around both the drive and driven sprockets in a conventional manner.

The amount of traction a motorized vehicle will have is dependent on a number of factors including weather, characteristics of the ground surface (e.g., dirt, mud, clay, sand), type of tires, and engine power and pulsations. The weather can be wet or dry conditions, while the dirt can range from being muddy to hard-packed dirt. Accordingly, dirt bike racers prepare for a race based on the weather and ground surface conditions.

For example, riders typically select particular tires to improve traction for the various types of ground conditions. The tires include knobs, which can vary in shape and spacing around the circumference of the tire. Further, the knobs extend around the sides of the tire to increase traction of the tire when the bike is being leaned into during a turn. The knob spacing provides the primary contact area with the ground, as well as a self-cleaning feature. If the knobs are spaced close together, there is generally more upper surface contact with the ground, and therefore greater traction. However, the spaces between the knobs are more prone to become filled or packed with loose dirt or mud, which can reduce the overall traction. Thus, there are tradeoffs that must be addressed when selecting a tire for particular ground surface conditions.

Two and four stroke engines, as well as various models within each engine category, can produce radically different traction characteristics, depending on the characteristics of the dirt (i.e., wet or dry, loose or packed), which influences the selection of tires and gearing to be used during a particular race. The engine pulse variable of the different types of engines creates different levels of traction that allows the rider to more easily slide the rear wheel, which is the most efficient way to turn or rotate the motorcycle in a new direction.

Forward motion of the vehicle is imparted by the engine power turning the rear wheel via the transmission and drive sprocket, chain and rear tire sprocket. While the motorcycle is accelerating in a straight line or in the turn, engine power pulses occur, and sudden rear wheel rotational surges effect rapid increases of rear tire velocity that usually shears the dirt layers, such that there is somewhat a loss of traction, but still results in forward motion. During this time of traction loss, the engine coasts such that there is a decrease in rear tire velocity, which allows the rear tire to regain traction.

Professional bike racers “tune” their dirt bikes based on the current weather and ground conditions. That is, the racers will bring different rear wheels with different rear hubs and sprockets, as well as different tires to a race in an attempt to maximize performance for the current racing conditions.

For example, changing the size and/or number of teeth on a sprocket affects the gearing ratio and can be advantageous for varying the performance of the bike for different types of uses. For cross-country use, a smaller sprocket produces higher speeds. For closed-course competition use, a larger sprocket produces quick acceleration.

Currently, there is no technique to adjust the rear wheel's pulsation to custom tailor it for all of the traction variables. Also, due to the substantial engine to rear-wheel (i.e., gearbox and driveline sprockets) ratio reduction, most of the engine pulsations are smoothed out to an almost imperceptible level.

Further, high performance rear sprockets can wear out quickly if they are the light weight types of aluminum sprockets used in high performance motorcycle riding. Replacing the entire sprocket can be expensive, and quick and easy changeability of rear sprockets having different sizes and number of teeth is currently limited.

U.S. application publication 20030199351 to Nichols discloses a motorcycle sprocket ring having outwardly protruding spaced teeth to engage the motorcycle drive chain and an inner circular flange to interconnect with the sprocket hub. The sprocket hub has an outer circular flange that mates with the inner circular flange of the sprocket ring. The sprocket ring can have different teeth configurations and be made of a different material than that of the hub. Mating holes in the flanges receive bolts therethrough to interconnect the ring and hub. Although sprocket ring is removable from the hub, the inner flange of the ring overlaps the outer flange of the hub, which increases the overall thickness of the rear sprocket, which is disadvantageous in dirt bike applications.

In particular, the swing-arm of a dirt bike is designed to have a much greater width than a swing-arm of a conventional street or racing bike to overcome the strenuous dirt track conditions. For example, dirt bikes have been known to traverse jumps exceeding 60 feet during races, which place enormous forces on the frame that must be absorbed at least in part by the swing-arms.

An advantageous feature in dirt bike and ATV design is to keep the profile of the bike as narrow as possible to add additional comfort for the rider, as well as to increase the clearance between the bike and ground to allow the rider to lean the bike into turns as much as possible without contacting the ground. As such, the increased width of the swing-arms is along the interior and adjacent the rear tire, such that the distance between the interior surface of the swing-arm and the exterior surface of the rear sprocket, as well as the tire is very narrow (e.g., less than ⅜ inch), as compared to conventional street bikes (e.g., greater than ⅜ inch). Since the drive chain is routed around the drive (front) sprocket, between the swing-arm and the rear tire, and over the driven (rear) sprocket, the maximum widths of the chain, and the drive and driven sprockets are limited in thickness to prevent or at least minimize the occurrences of the drive chain hitting the tire and/or swing-arm during operation.

The hub and sprocket ring combination of the Nichols patent is not suitable for dirt bike and ATV applications. Specifically, the arrangement of the overlapping hub and sprocket flanges can weaken, bend and even fail if they are fabricated too thinly. That is, the minimum thickness of the hub and sprocket is limited due to fabrication material considerations. To compensate, the overall thickness of the hub and sprocket combination of Nichols is increased to allow for the thin overlapping flange portions to maintain their integrity during operation. Therefore, since the width of the chain corresponds to the widths of the sprockets, the Nichols hub and ring sprocket would require a wider drive chain to be used, which would exceed the maximum tolerances between the swing-arm and the tire of the dirt bike.

U.S. Pat. No. 4,589,860, issued May 20, 1986 to Brandenstein, indicates a gear and method for making a gear having a body of cast material having a ring plate of metal embedded in the web section joining the hub and gear sections.

U.S. application publication 200400259674 to Pfister discloses a sprocket for a drive chain that includes a circular hub with a number of drive teeth that extend radially outwardly from the hub, and a plurality of guide teeth which are located between the drive teeth. The drive teeth, which are longer than the guide teeth, engage a corresponding pin of the drive chain for the transmission of force therebetween.

UK patent 2,099,543 discloses a non-circular sprocket drive wheel that has one or more lobes to increase and decrease the torque applied to the rear tire at least once during each rotation of the tire.

None of these prior patents provide a driven rear wheel hub with interchangeable sprockets that are suitable for use with dirt bikes and other motorized all terrain vehicles.

### SUMMARY OF THE INVENTION

The disadvantages heretofore associated with the prior art are overcome by the sprocket assembly of the present invention. The sprocket assembly is suitable for use with a motorized vehicle, for example, the rear tire of a motorcycle (e.g., dirt bike) or an all terrain vehicle (ATV). In one embodiment, the sprocket assembly includes a hub with an interchangeable sprocket ring. That is, the sprocket ring can be one of a plurality of sprocket rings that are interchangeable with the hub. Each sprocket ring can have a different configuration of outwardly spaced teeth that provide different levels of traction suitable for different track conditions.

The sprocket hub includes a plurality of outwardly extending flanges and means for mounting the sprocket hub to the vehicle. The means for mounting the sprocket hub to the vehicle can illustratively include one or more orifices for attaching the hub, for example, to the rear wheel or drive train of the vehicle.

The sprocket ring further includes a plurality of outer spaced teeth extending outwardly from the sprocket ring for engaging a drive loop of the vehicle. The sprocket ring further includes a plurality of inwardly extending flanges, each inwardly extending flange is configured to interface with a corresponding outwardly extending flange of the sprocket hub.

The sprocket ring is aligned and laterally secured to the sprocket hub by a plurality of removable fasteners. The sprocket ring is one of a plurality of interchangeable sprocket rings that can be mounted on the hub.

When joined together, the sprocket assembly is substantially planar, that is, the sprocket ring and the sprocket hub are fabricated from flat steel stock, and, when joined, comprise a planar surface. Only the heads of the threaded fasteners extend above the respective opposing lateral surfaces of the sprocket assembly.

As noted above, the sprocket ring can be one of a plurality of sprocket rings that are interchangeable with the hub. Each interchangeable sprocket ring has a different configuration of outer spaced teeth from another sprocket ring. The interchangeable sprocket rings are inexpensive to manufacture, and are easy to remove from and install on the hub. That is, a sprocket ring having an optimum tooth configuration for the current riding conditions can be installed by removing the presently installed sprocket ring and replacing (interchanging) it with the optimal sprocket ring.

Optionally, the sprocket ring can be a split sprocket ring. Preferably, the split sprocket ring is utilized on the rear tire of the motorcycle. In this embodiment, the sprocket ring can be removed from, and replaced on the hub without having to remove the rear wheel from the frame of the motorcycle.

In yet another embodiment, the sprocket includes an annular sprocket ring having an outer circumference, and an inner circumference having a plurality of inwardly extending flanges. The outer circumference is non-circular and includes a plurality of teeth extending outwardly from the ring for engaging a drive loop. The outer circumference of teeth is formed by a plurality of lobes and a plurality of corresponding substantially flat sections interleaved between the plurality of lobes. That is, adjacent lobes are separated by a substantially flat section of teeth. The lobes and flat sections transfer pulsed (i.e., increasing and decreasing) torsional forces originating from the drive loop to the drive wheel (e.g., rear wheel).

### BRIEF DESCRIPTION OF THE DRAWINGS

FIG. 1 depicts a plan view of an embodiment of a combination hub with an interchangeable sprocket in accordance with the principles of the present invention;

FIG. 2 depicts a plan view of another embodiment of the combination hub with an interchangeable sprocket in accordance with the principles of the present invention;

FIGS. 3A-3F depicts a partial plan views of alternative embodiments the hub and interchangeable sprockets;

FIGS. 4A and 4B respectively depict top-plan and side-elevational views of an illustrative fastener for securing the sprocket to the hub of FIG. 1;

FIG. 5 depicts a bottom perspective view of an another embodiment of the fastener of FIGS. 4A and 4B;

FIG. 6 depicts a cross-sectional view of the combination hub and interchangeable sprocket along line 6-6 of FIG. 2.

To facilitate understanding of the invention, the same reference numerals have been used, when appropriate, to designate the same or similar elements that are common to the figures. Further, unless stated otherwise, the drawings shown and discussed in the figures are not drawn to scale, but are shown for illustrative purposes only.

### DETAILED DESCRIPTION OF THE INVENTION

The present invention is discussed predominately as a hub and sprocket for a rear wheel of a motorcycle. However, one skilled in the art will appreciate that the embodiments disclosed herein are also applicable to other motorize vehicles, such race carts and other all terrain vehicles (ATVs) having a drive train that includes a rear hub and sprocket that is driven by a drive chain. Further, the present invention is also applicable to the forward or front drive hub and sprocket of a drive train.

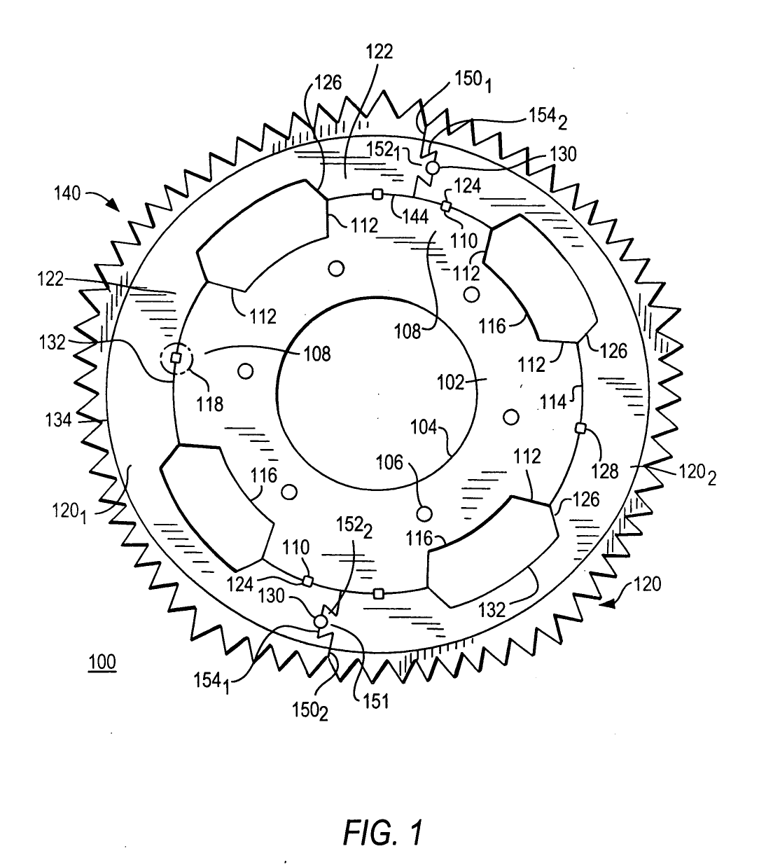

Referring to FIG. 1, the present invention is a two-piece sprocket and hub assembly 100 for a motorcycle, and preferably a motorcycle designed for dirt track racing, such as a “dirt bike.” The sprocket assembly 100 comprises a sprocket hub 102 and a sprocket ring 120. The sprocket hub 102 is annular in shape and includes an inner circumference 104 that circumscribes a bearing assembly of an axle, illustratively attached to a rear wheel of the motorcycle in a conventional manner. The outer circumference 116 of the hub 102 is substantially circular and includes a plurality of outwardly extending flanges 108 that are used to interface with and secure the sprocket ring 120, as discussed below in greater detail. The plurality of flanges 108 extend outwardly in the same plane as the hub 102. Preferably, the outwardly extending flanges 108 have the same thickness as the hub 102, although the flange thickness is not considered limiting.

The sprocket ring 120, and similarly the hub 102, can be fabricated from aluminum, stainless steel and the like. The sprocket ring 102 has a thickness in the range of approximately 0.25 to 0.33 inches. In one embodiment, the sprocket ring 120 has a thickness of approximately 0.325 inches along its inner circumference 132 and a thickness of approximately 0.25 inches at the point where teeth engage the chain. The hub 102 has a thickness substantially equal to the inner circumference 132 of the sprocket ring 120. In one embodiment, the sprocket ring 120 is substantially annular in shape and includes an inner circumference 132 that circumscribes the outer circumference 116 of the hub 12. The outer circumference 134 of the sprocket ring 120 can be circular or circular-like and includes a plurality of outwardly extending teeth 140 that are sized to interface with a drive loop (e.g., chain) of the motorcycle, as discussed below in greater detail.

The inner circumference 132 of the sprocket ring 120 includes a plurality of flanges 122 that interface (e.g., align and/or mate) with the plurality of flanges 108 extending outwardly from the hub 102. The plurality of flanges 122 extend inwardly in the same plane as the sprocket ring 120. Preferably, the inwardly extending flanges 122 have the same thickness as the outwardly extending flanges 108 of the sprocket ring 120, although the same thickness is not considered as limiting.

In the illustrative embodiment shown in FIG. 1, the plurality of outwardly extending flanges 108 of the hub 102 are illustratively configured as spoke members having an arcuate outer edge 114 that is concentric with the outer circumference 116 of the hub 102, and a pair of opposing sides 112 formed between the outer circumference 116 and the opposing ends of the arcuate edge 114.

Each inwardly extending flange 122 of the sprocket ring 120 is configured as spoke members having an arcuate edge 128 that is concentric and interfaces with an arcuate edge 114 of a corresponding outwardly extending flange 108, and a pair of opposing sides 126 formed between the inner circumference 132 and the opposing ends of the arcuate edge 128.

As shown in FIG. 1, the inwardly and outwardly extending flanges are aligned with each other such that the arcuate edges 114 and 128 interface, but do not interlock. The arcuate edges 114 include one or more grooves or cutouts 110, and similarly the arcuate edges 128 also include one or more corresponding grooves or cutouts 124. When the sprocket 120 is place on the hub 102, the grooves or cutouts are aligned to form an orifice 130 for receiving a fastener (drawn in phantom) 118, as discussed below in further detail.

In one embodiment, the sprocket ring 120 is split into sprocket ring section 120₁ and 120₂. Preferably, the sprocket ring 120 is divided into two equal sections. A split sprocket ring permits a user to advantageously remove the sprocket ring sections separately, and without having to remove the rear wheel from the frame of the bike.

The opposing ends of each sprocket ring section are configured to mate with each other, preferably an interlocking arrangement 151, to secure the sprocket ring sections circumferentially around the outwardly extending flanges 108 of the hub 102.

In one embodiment, the interlocking arrangement 151 between the opposing ends of the sprocket ring sections is provided via a dovetail configuration, such that one edge, such as edge 150₁ includes a dovetail flange 152₁ while the other edge 150₂ includes a dovetail cutout 154₁. For example, as illustratively shown in FIG. 1, the edge 150₁ of sprocket ring section 120₁ includes a dovetail shaped flange 152₁ which interlocks with the dovetail shaped cutout 154₂ of the second sprocket ring section 120₂. Similarly, the edge 150₂ of sprocket ring section 120₁ includes a dovetail shaped cutout 154₁ which interlocks with the dovetail shaped flange 152₂ of the second sprocket ring section 120₂.

Each dovetail flange 152 and dovetail shaped cutout 154 include a groove or cutout that form an orifice 130 when the opposing edges of the sprocket ring sections 120 are aligned and interlocked together. The orifices 130 are sized to receive a fastener to align and secure the sprocket ring sections laterally.

One skilled in the art will appreciate that other interlocking configurations are contemplated to join the opposing sprocket ring sections together. For example, opposing C-shaped flanges can readily be configured to interlock together, among other interlocking configurations.

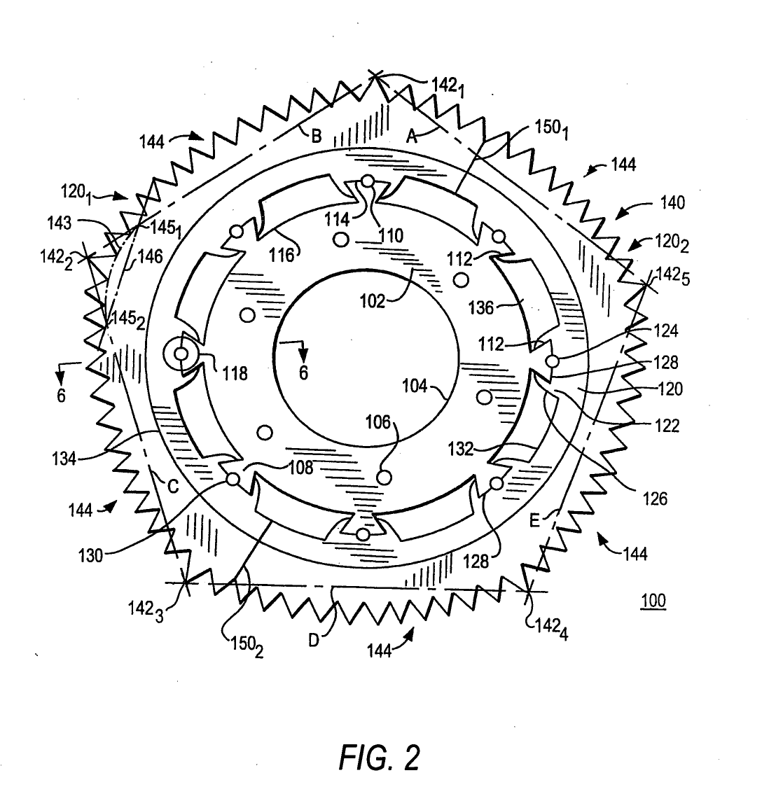

Referring to FIG. 2, another embodiment of the sprocket assembly 100 is shown. The sprocket assembly 100 of FIG. 2 is the same as the embodiment shown in FIG. 1, except that the outwardly extending flanges 108 and corresponding inwardly extending flanges 122, which serve as spokes between the hub and sprocket ring, are configured to interlock with each other.

In one embodiment, the plurality of outwardly extending flanges 108 are a dovetail shaped, such that the pair of opposing sides 112 are angled outwardly from the outer circumference 116 to the ends of the arcuate edge 114, although such shape is not considered as limiting.

Each inwardly extending flange 122 of the sprocket ring 120 includes opposing sides 126 and a central cutout or receptacle 128 that is sized and shaped to receive a corresponding outwardly extending male flange 108 of the hub 102. Thus, the inwardly extending flanges 120 form female interfaces for interconnection with the male flanges 108 of the sprocket ring 102. In the preferred embodiment, the receptacles 128 are dovetailed in shape.

In one embodiment, each outwardly extending flange 108 of the hub 102 includes a semicircular groove 110 centrally formed along the arcuate edge 114 of the flange. Similarly, each inwardly extending flange 122 of the sprocket ring 120 includes a semicircular groove 124 formed centrally along the back edge of the flange 122 that defines the receptacle 128.

When the sprocket ring 102 is attached to the hub 102, each outwardly extending flange 108 is received by a corresponding receptacle 128 of an inwardly extending flange 122, such that the grooves 110 and 124 are aligned to form a circular orifice 130. The grooves 110 and 124, and thus the orifices 130, are sized to receive a fastener 118 for securing the sprocket ring 120 to the hub 102.

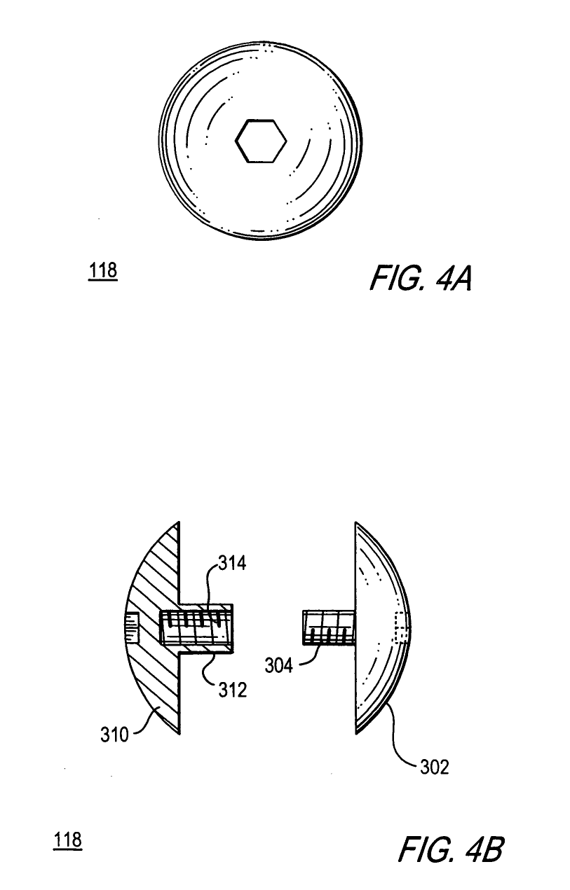

Referring to FIGS. 4A and 4B, in one embodiment, the fastener 118 is a bolt 302 that traverses through the orifice 130 in a direction normal to the hub 102 and ring sprocket 120, which is subsequently secured with a nut 318. Preferably, the bolt 302 and nut are pan-shaped. In one embodiment, the nut includes a shaft 312 positioned normal to the head of the nut and extending approximately a length equal to the thickness of the sprocket ring 120 and hub 102. Preferably, the shaft 312 is provided with an internally threaded receptacle 314 positioned normal to the head of the nut. The receptacle 312 receives a threaded shaft 304 of the bolt 302. Thus, the receptacle 312 has an external diameter that is sized to be received by the orifice 130. The receptacles 312 are provided on the nuts 310 as a safeguard to prevent centrifugal forces, which act on the groove edges that form the orifice 130 during tire rotation, from destroying the threads of the bolt 118, and thereby making it difficult to remove the bolts during maintenance or interchanging of the sprocket ring.

The heads of the bolt 302 and nut 310 have a diameter that is greater than the diameter of the orifice 130. When tightened, the fastener 118 aligns and then secures the planar sides of the flanges 108 and 122 together. In one embodiment, the heads of the bolts and nuts have a diameter that is 25% to 250% larger than the diameter of the orifices 130, and preferably 100%. If, for example, the diameter of the orifice 130 is 7 mm to 12 mm, then the diameter of the pan-shaped bolt 302 and nut heads 310 are preferably 16 to 30 mm.

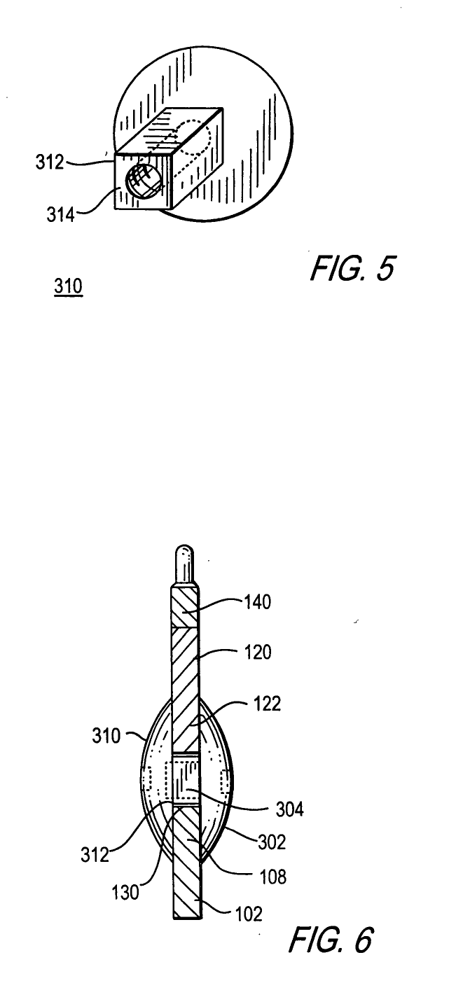

Referring to FIG. 5, another embodiment of the fastener 118 is shown. The fastener of FIG. 5 is the same as the embodiment shown in FIG. 4B, except that the shaft 312 is keyed to match a keyed shaped orifice 130 formed by the paired hub and sprocket flanges. As illustratively shown in FIG. 1, a plurality of square orifices 130 are provided for receiving the square shaft 312 of the nut 310. Other keying shapes can be utilized, such as a single flat side, and the like. The keyed orifice 130 and corresponding keyed shafts 312 on the fastener nuts 310 allow the user to remove and tighten the fasteners 118 by having to only rotate the bolt 302, while the nut 310 remains in a locked position by the one or more keyed surfaces of the shaft 312 interfacing with the correspondingly keyed orifice 130.

Referring to FIG. 6, a cross-sectional view along line 6-6 of FIG. 2 is shown. FIG. 6 illustrates the alignment of the hub 102 and sprocket ring 120. Specifically, the outwardly extending flange 108 and inwardly extending flange 120 are interconnected as discussed above, such that the grooves 110 and 124 define the orifice 130. The shaft 312 of the nut 310 is traversed through the orifice 130 and the bolt 302 is tightened to a predetermined torque value, such that the opposing flat surfaces of the bolt and nut heads secure the sides of the flanges 108 and 122.

In one embodiment, the shaft 312 of the nut has a length greater than the thickness of the hub and spoke flanges to permit the sprocket ring 120 to essentially float on the hub. The shaft 312 can be in a range of 0.002 to 0.005 thousandths of an inch greater to allow for thermal expansion of the sprocket and hub during operation.

As illustratively shown in FIGS. 1 and 2, eight outwardly extending male flanges 108 interface with eight inwardly extending female flanges 122 in an equally spaced, i.e., symmetrical, pattern. As such, a plurality of openings 136 is formed between the outer circumference 116 of the hub 102 and the inner circumference 134 of the sprocket ring 120. The openings 136 are interleaved between each pair of flanges. Each opening 136 is formed by the inner circumference edge 132 of the sprocket ring 120, the outer circumference edge 116 of the hub 102, and the opposing sides 126 of the flanges. The openings 136 reduce the overall weight and provide additional ventilation for the combination hub and sprocket ring (i.e., sprocket assembly) 100.

The number of paired outwardly and inwardly extending flanges is not limiting, however, it is preferable that the flanges 108 and 122 be formed in a symmetrical pattern around the outer circumference 116 of the hub 102. The number of paired flanges (108/122) is a design choice based on various factors including the size and fabrication materials of the hub and sprocket ring.

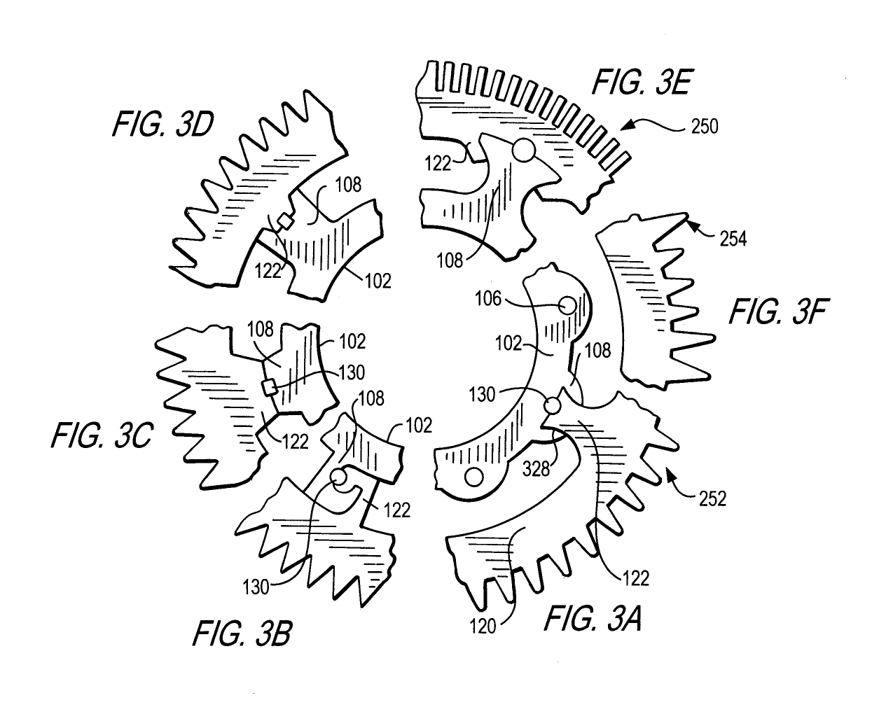

Referring to the partial plan views of the sprocket assembly 100 in FIGS. 3A-3F, various alternative embodiments of the combination hub and interchangeable sprocket ring 100 are shown. One skilled in the art will appreciate that the male/female flanges can be reversed on the hub 102 and sprocket ring 120. Referring to FIG. 3A, one or more inwardly extending sprocket flanges 122 can be formed as a male flange, such as the dovetail shaped flange, and the corresponding outwardly extending hub flanges 108 include a receptacle 328 for receiving the male (dovetail) flange 122.

Referring to FIG. 3B, the flanges 108 and 122 are formed in a substantially C-shaped configuration, such that the two corresponding flanges interlock, as shown. Although the interlocking C-shaped flanges are generally curved in shape, one skilled in the art will appreciate that generally linear C-shaped flanges can be utilized, as well as other shapes that are configured to interlock.

Referring to FIG. 3C, a pair of non-interlocking flanges are shown with the opposing flanges 108 and 122 interfacing approximately midway between the outer circumference 116 of the hub 102 and the inner circumference 132 of the sprocket ring 120. Alternatively, the edges of the opposing flanges 108 and 122 can interface proximate the outer circumference 116 of the hub 102, or the proximate the inner circumference 132 of the sprocket ring 120 as illustratively shown in FIG. 3D.

For any of the various embodiments of the interlocking and non-interlocking paired flanges 108 and 122 described above, a fastener 118 secures the flanges 208 and 222 through orifices 130 in a similar manner as discussed above with respect to FIGS. 1 and 2. FIGS. 3A-3F illustratively depict the orifice 130 as being circular or keyed, such as by having one or more flat surface (e.g., a square orifice 130).

As such, the dovetail or similar shape of the flanges 108 and flange receptacles 122 secure the hub and sprocket together to prevent centrifugal forces from separating the sprocket ring 120 from the hub 102 as the wheel rotates. Additionally, the fasteners 118 prevent lateral forces from separating sprocket ring 120 from the hub 102.

Referring to FIG. 2, the combination hub 102 and sprocket ring 120 can also be split into sprocket sections 120₁ and 120₂ to form a split sprocket ring, in a manner as described above with respect to the embodiment of FIG. 1. However, the interlocking paired flanges 108 and 122 (with the fasteners 118) advantageously maintain the sprocket ring sections 120₁ and 120₂ about the outer circumference 116 of the hub 102 during operation. The interlocking arrangement 151 (i.e., flange 152 and cutout 154) formed along each edge 150 of the sections 120₁ and 120₂ as provided in the non-interlocking flange arrangement of FIG. 1, is not required for the interlocking flange arrangement utilized as provided in the embodiment of FIG. 2.

Accordingly, the split sprocket ring enables a racer to tune the drive train of the dirt bike by interchanging a sprocket ring with another without having to remove the rear wheel from the frame.

The sprocket ring 120 includes a plurality of outwardly extending teeth 140. The teeth are sized to be inserted through spaces formed in the links of the drive chain in a conventional manner. As such, different tooth counts and tooth shapes can be provided on a sprocket ring 120 to accommodate different drive trains, as well as riding or racing conditions. For example, as illustratively shown in FIG. 3E, the shape of the teeth can be substantially rectangular 250, substantially triangular 252 (FIG. 3A), and the like, or a combination thereof, as well as include variations in tooth heights 254 as illustrated in FIG. 3F.

Referring to FIG. 2, the present invention further contemplates a pulsed sprocket assembly 100, which includes a non-circular outer circumference 134 formed by a plurality of toothed lobes 142. The lobes 142 are dispersed symmetrically to form the outer circumference 134 of the sprocket wheel 120. A plurality of flattened areas 144 having teeth are interleaved between the plurality of lobes 142. That is, a single flattened area 144 is formed between adjacent lobes 142. The teeth 140 extend outwardly from the lobes 142 and flattened areas 144 in a conventional manner.

The drive chain transmits the torsional forces to the sprocket assembly 100, which in turn causes the rear wheel to rotate in a conventional manner. However, the lobed portions 142 of the present invention increase the torsional forces to the rear wheel, while the flattened portions 144 of the sprocket ring decrease the torsional forces applied to the rear wheel. As such, the interleaved lobes 142 and flattened portions 144 of the sprocket assembly 100 provide a pulsed torsional effect to the wheel by sequentially increasing and decreasing the torsional forces transmitted from the drive chain.

As illustratively shown in FIG. 2, five lobes are formed equidistant apart to define five apexes. The substantially flattened areas are illustrated by lines A-E (drawn in phantom) to form a somewhat pentagonal shape of the sprocket ring 102. For example, one end of lines A and B intersect at a first lobe or apex 142₁, the second end of line B intersects with the first end of line C at lobe 142₂, the second end of line C intersects with the first end of line D at lobe 142₃, and so forth.

The number of lobes 142 with corresponding flattened areas 144 is dependent on the overall diameter of the sprocket assembly 100, among other factors, such as tuning considerations for improving traction and acceleration. Each lobe 142 has a curvature as shown by phantom line 143 (near lobe 142₂) that intersects at each end with adjacent flattened areas 144. The curvature 143 is defined by a radius that is less than the radius that forms the outer circumference of the flattened areas 144. The curvature 143 illustratively intersects with line B (which represents a line tangent to the flattened area between lobes 142₁ and 142₂) at point 145₁, and similarly intersects with adjacent line C (which represents a line tangent to the flattened area between lobes 142₂ and 142₃) at point 145₂. In one embodiment, the optimal distance between the intersecting points 145₁ and 145₂, as illustratively shown by phantom line 146, is between ¼ and 2 inches.

A lobe 142 formed with a single tooth and extending a distance along line 146 less that ¼ inch is susceptible to excessive stresses by the drive chain during operation which can damage the tooth and sprocket. Conversely, when the lobes 142 are formed with multiple teeth and extend a distance along line 146 greater than 2 inches, the lobes 142 essentially flatten out, such that the overall shape of the sprocket ring becomes substantially circular, thereby nullifying the advantages of providing a pulsed sprocket ring.

In one embodiment, the number of lobes can range between four and twelve lobes. Sprocket ring having more than nine lobes become effectively become substantially circular in shape, which diminishes the desired pulsed torsion effects of the sprocket. Preferably, the sprocket ring 120 includes an odd number of lobes, such as five or seven lobes 142.

The pulsed sprocket assembly 100 can be implemented with a unitary sprocket, where the hub is integral (non-separable) with the sprocket ring or with the interchangeable hub and sprocket combination, as illustrated in FIGS. 1-3F. The number of teeth formed on the outer circumference 134 of the sprocket is a design consideration that is dependent on the diameter of the sprocket, the type of drive chain, tuning considerations for improving traction and acceleration, among others. Preferably the sprocket includes 35 to 60 teeth formed on the outer circumference 134, although such number is not limiting.

The present invention provides various embodiments to fine tune the performance of a motorized vehicle, such as a dirt bike. The interchangeable hub and sprocket combination 100 enables the rider to interchange the sprockets on the rear tire based on the road/dirt conditions at any given time. That is, the rider can interchange the sprocket ring having a particular diameter, tooth count and/or number of pulses with another sprocket ring having a different diameter, tooth count and/or number of pulses. As such, the rider can obtain a set of sprocket rings, wherein each sprocket ring has a different configuration of outer spaced teeth, to fine tune the performance of the bike based on the road conditions.

For example, if a dirt bike performs optimally with a sprocket having a tooth count between 45 and 51 teeth, and between six and nine pulses, then seven tooth variables (45-51) for each of the four pulsed sprockets (6-9) would require twenty-eight sprocket rings. Assuming, for example, there are twenty different types of rear wheels, then twenty different hubs would be required. Thus, a merchant would be required to hold in inventory 48 (28+20) different components. By comparison, without the interchangeable sprocket ring feature of the present invention, a merchant would have to hold in inventory 560 (28×20) components. Accordingly, the present invention provides quite a savings in terms of inventory costs.

As noted above, the lobes 142 increase the torque to the rear wheel, while the flattened portions 144 decrease the torque to the wheel. The pulsed rear sprocket helps increase traction between the rear tire and the ground. This improvement in traction is advantageous while the rider is accelerating or turning the dirt bike, since traction between the rear tire and the ground is often diminished while turning. The pulsed sprocket transfers the power and acceleration from the drive train to improve the traction between the rear wheel and the ground, which improves the overall driving experience for the rider.

Although various embodiments that incorporate the teachings of the present invention have been shown and described in detail herein, those skilled in the art can readily devise many other varied embodiments that are within these teachings and the scope of the invention is to be determined with reference to the claims that follow.

I claim:

1. A sprocket assembly (100) for a vehicle comprising:
a sprocket hub (102) having a plurality of outwardly extending flanges (108) and means for mounting said sprocket hub to said vehicle;
a sprocket ring (120) having outer spaced teeth (140) extending outwardly from the ring for engaging a drive loop of the vehicle, and having a plurality of inwardly extending flanges (122), each inwardly extending flange being configured to interface with a corresponding outwardly extending flange of the sprocket hub, said sprocket ring being aligned and laterally secured to the sprocket hub by a plurality of removable fasteners, wherein said sprocket ring is one of a plurality of interchangeable sprocket rings for mounting on said hub.

2. The sprocket assembly of claim 1, wherein each flange of the ring is provided with a first semi-circular recess (124), and each flange of the hub is provided with a semi-circular recess (110), wherein pairs of first and second semi-circular grooves are aligned to define a plurality of spaced apart circular orifices (130) adapted to receive a corresponding one of said plurality of fasteners.

3. The sprocket assembly of claim 1, wherein each of the interchangeable sprocket rings having a different configuration of outwardly extending spaced teeth.

4. The sprocket assembly of claim 1, wherein said corresponding inwardly and outwardly extending flanges have non-interlocking contact surfaces.

5. The sprocket assembly of claim 1, wherein said corresponding inwardly and outwardly extending flanges have interlocking contact surfaces.

6. The assembly sprocket of claim 5, wherein each of said inwardly and outwardly extending flanges include at least one of an interlocking dovetail configuration and an interlocking C configuration.

7. The sprocket assembly of claim 1, wherein the orifices and corresponding fasteners are keyed.

8. The sprocket assembly of claim 1, wherein each fastener includes a pan-head bolt and pan-head nut.

9. The sprocket assembly of claim 1, wherein the teeth extending from the sprocket ring define a plurality of lobes along the circumference of the ring and a plurality of substantially flat sections formed between adjacent lobes.

10. The sprocket assembly of claim 9, wherein said sprocket ring includes three to nine lobes.

11. The sprocket assembly of claim 1, wherein said sprocket ring comprises a pair of sprocket ring sections forming a split sprocket ring.

12. The sprocket assembly of claim 1, wherein said sprocket ring sections are joined at opposing ends in an interlocking configuration.

13. The sprocket assembly of claim 12, wherein said interlocking arrangement includes a configuration selected from the group consisting of at least one of an interlocking dovetail configuration and an interlocking C configuration.

14. The sprocket assembly of claim 1, wherein said hub is mounted on a wheel of said vehicle.

15. A sprocket assembly (100) comprising:
A first sprocket ring (120) including an inner circumference having a plurality of inwardly extending flanges (122), and a non-circular outer circumference defined by a plurality of teeth (140) extending outwardly from the ring for engaging a drive loop, said outer circumference being formed by a plurality of lobes and a plurality of substantially flat pulse sections, each pulse section being interleaved between adjacent lobes; and
a sprocket hub (102) having a plurality of outwardly extending flanges (108), each flange adapted to interface with a corresponding inwardly extending flange, such that the first sprocket ring circumscribes said hub; and
a plurality of detachable fasteners (118), each fastener maintaining a corresponding pair of ring and hub flanges in lateral alignment, wherein said first sprocket ring is interchangeable with at least a second sprocket ring upon removal and replacement of said fasteners.

16. The sprocket assembly of claim 15, wherein each sprocket ring has a different configuration of outwardly extending teeth.

17. The sprocket assembly of claim 15, wherein said corresponding inwardly and outwardly extending flanges have non-interlocking contact surfaces.

18. The sprocket assembly of claim 15, wherein said corresponding inwardly and outwardly extending flanges have interlocking contact surfaces.

19. The assembly sprocket of claim 18, wherein each of said inwardly and outwardly extending flanges include an interlocking configuration selected from the group consisting of an interlocking dovetail configuration and an interlocking C configuration.

20. The sprocket assembly of claim 15, wherein said sprocket ring comprises a pair of sprocket ring sections forming a split sprocket ring.
